(19) United States
(12) Patent Application Publication
(10) Pub. No.: US 2004/0262107 A1
(43) Pub. Date: Dec. 30, 2004

(54) Shock absorber having a pressurized gas compartment

(76) Inventor: Srinath Nandyal, Pulaski, TN (US)

Correspondence Address: MCANDREWS HELD & MALLOY, LTD, 500 WEST MADISON STREET, SUITE 3400, CHICAGO, IL, 60661

(21) Appl. No.: 10/490,094

(22) PCT Filed: Sep. 24, 2002
(86) PCT No.: PCT/US02/30207

Related U.S. Application Data
(60) Provisional application No. 60/324,301, filed on Sep. 24, 2001.
(60) Provisional application No. 60/346,568, filed on Jan. 8, 2002.

(51) Int. Cl. F16F 9/12; F16F 9/06

(52) U.S. Cl. 188/314; 188/269; 188/266; 188/315

(57) ABSTRACT

A shock absorber includes a gas compartment within its reservoir compartment. The gas compartment contains gas at a pressure beyond atmospheric pressure. The gas compartment may be defined by an elastomeric bladder which separates the fluid and gas in the shock from one another, and prevents the fluid from becoming aerated during operation of the shock. Because the shock absorber is pressurized beyond atmospheric pressure, the shock absorber provides a “spring assist” to the main suspension spring. The bladder acts as diaphragm and pressure in the bladder is directly transmitted to the fluid. As the main chamber of the shock absorber is replenished with fluid from the reservoir chamber, the gap in the reservoir chamber is taken up by the ever-expanding bladder, and no cavitation occurs in another embodiment, the bladder is replaced by a member mounted for reciprocal sealing movement within the reservoir compartment.

### RELATED APPLICATIONS

This application claims priority of U.S. provisional application Ser. No. 60,324,301, filed Sep. 24, 2001, the disclosure of which is incorporated herein in its entirety.

### BACKGROUND OF THE INVENTION

Shock absorbers are commonly used in vehicle suspension systems to absorb unwanted vibrations, which occur during driving. Specifically, shock absorbers are generally connected between the body (sprung mass) and the suspension (unsprung mass) of the vehicle to “dampen” vibrations transmitted from the suspension to the body.

Vehicle shock absorbers typically have a hollow cylinder defining an internal chamber, which is divided into a compression compartment and a rebound compartment by a piston assembly slidably positioned in the internal chamber. Such shock absorbers incorporate a reservoir for hydraulic fluid (oil). The reservoir provides a space in communication with the internal chamber that can receive fluid displaced from the internal chamber, and from which the displaced fluid can return into the shock absorber internal chamber.

The shock absorber includes internal valving that permits fluid to flow between the compression and rebound compartments as the piston moves within the internal chamber. One end of the cylinder is closed and is typically connected to the vehicle suspension by a suitable linkage. A piston rod extends through a seal assembly mounted in the other end of the cylinder and has its inner end connected to the piston and its outer end connected to the vehicle body by a suitable connector. The piston assembly limits the flow of damping fluid within the internal chamber of the shock absorber during compression and extension of the shock, thereby providing a damping force, which “smoothes” or “dampens” vibrations transmitted from the suspension to the body.

The reservoir of the shock absorber provides a space into which fluid can be displaced from the internal chamber during reciprocating motion of the piston within the internal chamber. During the compression stroke, a volume of fluid equal to the displacement of the piston rod is displaced from the shock absorber cylinder, through suitable valves in the piston and the base of the cylinder, and into the reservoir. Conversely, during the rebound stroke, the volume of fluid that was displaced from internal chamber during the compression stroke is returned to the internal chamber through a low resistance valving to refill the internal chamber.

To provide a space for the pulsing action of the hydraulic fluid between the internal chamber and the reservoir, a volume of air is retained in the reservoir. However, during operation of the shock, the movement of fluid into and out of the reservoir can cause a high degree of turbulence of the fluid and air in the reservoir. Because the air and fluid are in contact with one another, this turbulence can cause the hydraulic fluid to become aerated. Aeration of the hydraulic fluid can adversely effect the performance characteristics of the shock absorber by changing the flow characteristics of the fluid through the valving in the piston and the cylinder base. In addition, in order to retain the air in the reservoir chamber, such designs must generally be mounted in a substantially vertical orientation. Specifically, these designs generally should not be mounted more than 50 degree from vertical, nor can they be mounted in an inverted position or a horizontal orientation.

In order to reduce this aeration effect in the hydraulic fluid, it is known to use deformable gas compartments or cells within the reservoir chamber. Examples of such prior designs can be found in the following U.S. Pat. Nos. 2,799,291; 3,024,875; and 3,123,347. While these prior gas cell shock absorbers designs may adequately prevent adverse aeration of the hydraulic fluid and allow other than vertical mounting of the shock, they do not allow for pressurization of the shock absorber. Shock absorbers of other designs are often pressurized with gas to a pressure beyond atmospheric pressure so that the shock absorber provides a “spring assist” to the main suspension spring, thereby improving vehicle cornering and the “patch contact” of the vehicle's tire with the road. Hence, it is not possible to achieve the desirable performance characteristics of a pressurized shock absorber with these prior gas cell shock absorbers.

### BRIEF SUMMARY OF THE INVENTION

A shock absorber according to certain aspects of an embodiment of the present invention comprises an inner cylinder defining an internal chamber that has a rod end and a base or closed end. A piston assembly is slidably mounted for reciprocal movement within the internal chamber in a compression stroke direction and in a rebound stroke direction. A piston rod is connected to the piston assembly and extends from the rod end of the internal chamber. A closure assembly closes the rod end of the internal chamber and slidably and sealingly engages about the piston rod. An outer cylinder defines a fluid reservoir compartment that is in fluid communication with the internal chamber. A deformable gas compartment is positioned in the reservoir compartment. The gas compartment contains a gas at a pressure in excess of atmospheric pressure. Hydraulic fluid filing all of portions of the internal chamber and the reservoir except for the gas compartment. The gas compartment includes a wall formed from an elastomeric material. The wall physically separates the gas in the gas compartment from the hydraulic fluid. The elastomeric wall allows the gas compartment to expand and contract as fluid flows into and out of the reservoir. The high pressure in the chamber maintains constant contact between the elastomeric wall and the fluid. Hence, the gas compartment acts as diaphragm and pressure in the compartment (diaphragm) is directly transmitted to the fluid. The wall may include an inner section that is generally constrained by the inner cylinder, an outer section that is generally constrained by the outer cylinder, and a generally U-shaped section interconnecting the inner and outer sections. The U-shaped section being unconstrained so that it can expand and contract as fluid flows into and out of the reservoir.

Alternatively, the gas compartment may comprise a member mounted for reciprocal sealing movement within the reservoir compartment. The member divides the reservoir compartment into a gas compartment and fluid compartment, the relative sizes of which vary in accordance with the position of the member within the reservoir compartment. A gas in excess of atmospheric pressure fills the gas compartment and hydraulic fluid fills all of portions of the internal chamber and the reservoir except for the gas compartment. The member may be generally ring shaped and may be constructed from an elastomeric material. The member has an inner diameter forming an interference fit with an outer diameter of the inner cylinder and an outer diameter forming an interference fit with an inner diameter of the outer cylinder.

### BRIEF DESCRIPTION OF SEVERAL VIEWS OF THE DRAWINGS

FIG. 1 is cross-sectional view of a shock absorber according to certain aspects of an embodiment the present invention.

FIG. 2 is an enlarged view of a portion of FIG. 1.

FIG. 3 is a cross-sectional view of a second embodiment of a shock absorber according to certain aspects of the present invention.

FIG. 4 is a cross-section view of a third embodiment of a shock absorber according to certain aspects of the present invention.

The foregoing summary, as well as the following detailed description of the preferred embodiments of the present invention, will be better understood when read in conjunction with the appended drawings. For the purpose of illustrating the preferred embodiments of the present invention, there is shown in the drawings, embodiments which are presently preferred. It should be understood, however, that the present invention is not limited to the arrangements and instrumentality shown in the attached drawings.

### DETAILED DESCRIPTION OF THE INVENTION

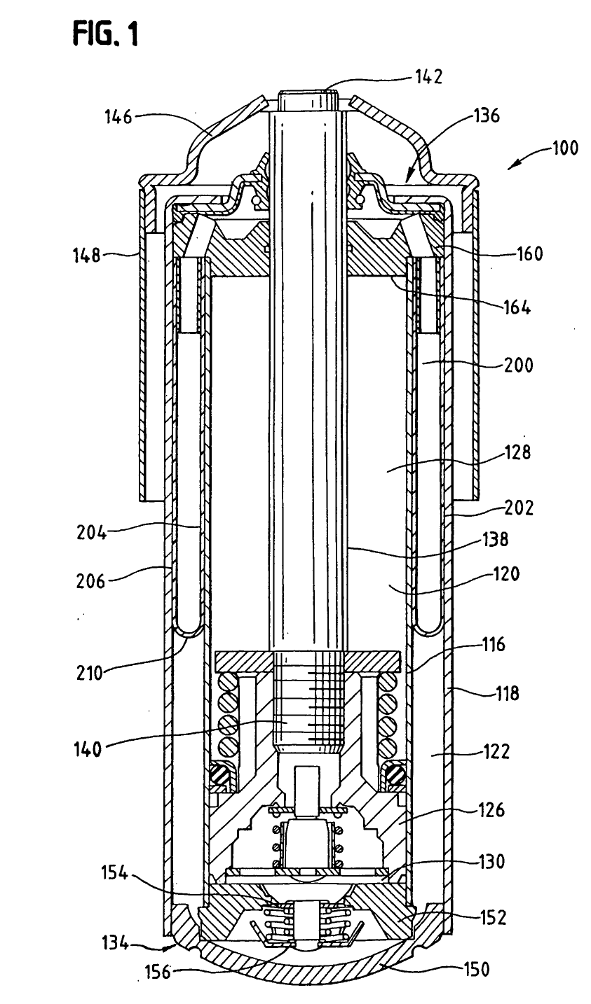

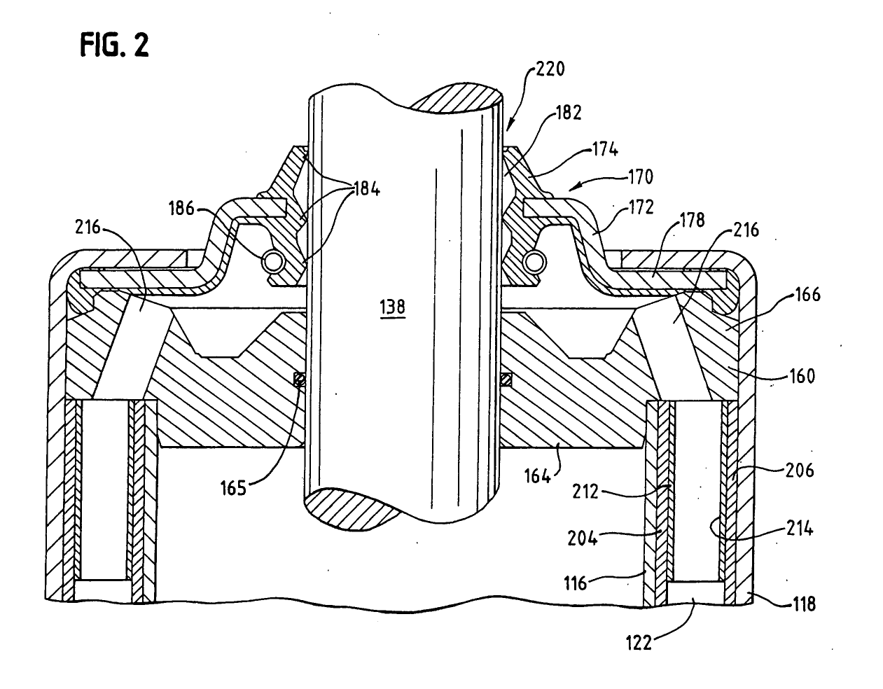

FIGS. 1 and 2 illustrate an embodiment of a shock absorber according to certain aspects of an embodiment of the present invention. The shock absorber 100 incorporates a number of assemblies, subassemblies and component parts that are of conventional design and construction. Except as otherwise noted below, these assemblies and parts, as utilized with the shock absorber 100, may be generally constructed in the manner disclosed in U.S. Pat. Nos. 4,310,077; 5,234,084; and 6,343,677, and the disclosures of these patents are hereby incorporated by reference. More specifically, the shock absorber 100 includes inner and outer cylinders 116, 118 that extend coaxially and concentrically in a conventional manner. The inner cylinder 116 defines an internal chamber or cavity 120, and the annular space between the inner and outer cylinders 116, 118 defines an annular reservoir compartment 122.

A conventional piston or, more specifically, piston assembly 126, is slidably mounted within the internal chamber 120 and divides the internal chamber 120 into a rebound compartment 128 and a compression compartment 130. The volumes of the compartments 128 and 130 vary in accordance with the position of the piston assembly 126 within the chamber 120.

As is conventional, the end of the shock absorber 100 adjacent the rebound compartment 128 (that is, the upper end as shown in FIG. 1) is sometimes referred to as the open end or rod end. Conversely, the end adjacent the compression compartment 130 (that is, the lower end as shown in FIG. 1) is commonly referred to as the closed end. The ends of the cylinders 116, 118 adjacent the closed end of the shock absorber 100 are closed by an end cap assembly 134. The ends of the cylinders 116, 118 adjacent the rod end are closed by a rod end closure assembly 136.

A piston rod 138 has an inner end 140 connected with the piston assembly 126. The outer end 142 of the rod 138 slidably and sealably projects through the closure assembly 136 in a conventional manner. The outer end 142 of the rod carries a member 146 that, in turn, supports a dust shield 148.

The shock absorber 100 is adapted to be connected between two masses, for instance, between the vehicle's body and the vehicle's suspension. For this purpose, an eye connector (not shown) is typically secured to the center of the exterior surface of the end cap assembly 134 for securing the shock absorber 100 to the vehicle's suspension. Similarly, the outer end 142 of the piston rod 138 is typically threaded to permit it to be secured to a mounting aperture on the vehicle's body by, for example, by a reciprocal nut. Alternatively, the outer end 142 of the piston rod 138 could also include an eye connector. It will be appreciated that these connections can be reversed, i.e., the closed end of the shock can be connected to the vehicle's suspension and the piston rod 138 can be connected to the vehicle's body.

The end cap assembly 134 includes an end cap member 150 and a valve cage member 152. The end cap member 150 is connected, e.g., by welding, to the lower end of the outer cylinder 118 so as to seal and close the lower end of the outer cylinder 118. The valve cage 152 provides fluid passages (not shown) which permit unrestricted fluid communication between the reservoir compartment 122 and the space or volume defined between the valve cage member 152 and the cap member 150. The valve cage member 152 mounts a replenishing valve 154 and a compression valve 156. During the compression stroke of the piston assembly 126, increasing pressure in the compression compartment unseats the compression valve 156 and biases the replenishing valve 154 closed. When this occurs, a quantity of fluid, equivalent to the piston rod volumetric displacement, will flow from the internal chamber 120 through the compression valve 156, and then through passages in the valve cage member 152 and into the reservoir 122. Conversely, during the rebound stroke, decreasing pressure in the compression compartment biases the compression valve 156closed and the replenishing valve 154 open, allowing fluid to flow from the reservoir 122, through the replenishing valve 154 and into the internal chamber 120. Simultaneously, increasing pressure in the rebound compartment 128 is transmitted through passages and valves in the piston assembly 126, permitting fluid to flow between the rebound compartment 128 and the compression compartment 130.

The rod end closure assembly 136 includes an inner head member 160 that closes the rod end of the inner cylinder 116. The inner head 160 has a reduced diameter lower portion 164, which is press fit into the inner cylinder 116, and a central aperture sized to slidably engage the piston rod 138. A seal 165, such as an O-ring, is disposed within the central aperture and seals about the outer surface of the piston rod 138. The seal 165 functions to retain the hydraulic fluid within the internal chamber 120. The inner head 160 further includes an increased diameter upper flange 166 that extends radially towards the outer cylinder 118.

The rod end closure assembly 136 further includes a seal subassembly 170 comprising a metallic outer cap 172 and an elastomeric seal member 174. Both the cap 172 and the member 174 have respective central apertures sized to slidably engage about the piston rod 138. The cap 172 also includes a lower leg 178, which is fixedly joined to the outer cylinder 118, to secure the seal subassembly 170 in the rod end of the shock absorber 100. The central aperture 182 of the seal member 174 includes a plurality of lips or ridges 184 which scrape against the outer diameter of the piston rod 138 to remove excess shock absorber fluid from the piston rod as it moves out of the internal chamber 120. A garter spring 186 secured around the seal member 174 functions as a mechanical spine for the seal member.

It will be understood that the construction of the shock absorber 100 as thus far described is similar to the shock absorbers described in the aforementioned patents. It will also be understood that the assemblies, subassemblies, and components thus far described may assume other designs, constructions or configurations without departing from the scope of the present invention.

The shock absorber 100 includes a novel gas containing structure or compartment 200 within the reservoir. In the embodiment of FIGS. 1 and 2, the gas compartment 200 includes an inflatable bladder 202. The bladder 202 is preferably formed from an elastomeric material which is impermeable to hydraulic fluid flow into the gas compartment and impermeable to gas flow out of the gas compartment. The bladder material should be selected so that it remains elastomeric between −40° F. and 275° F., which is the typical range of operating temperatures for a shock absorber, and can withstand pressures several times greater than atmospheric pressure. One suitable material is Vamac as is available from E.I. du Pont de Nemours and Company

In the embodiment shown in FIG. 1, the inflatable bladder 202 includes inner and outer side walls 204, 206 and a generally U-shaped bottom wall 210. The upper end of the inner wall 204 is secured to the inner cylinder 116 by a clamp 212. Similarly, the upper end of the outer wall 206 is secured to the outer cylinder 118 by a clamp 214. The upper end of the bladder is open and is in fluid communication with flow passages 216 formed in the head member 160. The bladder 202 is pressurized, e.g., during assembly of the shock absorber, to a pressure above atmospheric pressure. This can be accomplished by directing high pressure gas between the piston rod 138 and the seal 174, as is generally indicated by the arrow 220 in FIG. 2. The seal is displacable, e.g., by gas pressure and/or a portion of the inflation device to allow the gas to flow past the seal. The gas flows through the flow passages 216 and into the bladder 202. Once the pressurization process is complete, the seal 174 functions to retain the pressurized gas within the bladder. The exact pressure of the gas within the compartment 200 will depend on the specific application. In a typical application the pressure will be in the range of 150 psi to 250 psi.

As the inflatable bladder 202 is pressurized, expansion of its inner and outer walls 204, 206 will be constrained by the inner and outer cylinders 216, 218, respectively. During assembly, the shock absorber 100 is filled with fluid, so that the volume of the fluid is more than normal but less than full. Hence, increasing pressure will cause the bottom wall 210 of the bladder 202 to expand downwardly and into contact with they hydraulic fluid in the reservoir 122. Expansion of the bladder displaces fluid in the cylinder to fill any empty spaces and any free air is dissolved into the fluid. As a result, hydraulic fluid fills all of the internal chamber 120 and all portions of the reservoir 122 except for the gas compartment.

The bladder 202 functions to separate the hydraulic fluid in the shock absorber from the gas, thereby prevent aeration (foaming) of the fluid. The bladder 202 also functions to retain the gas in the reservoir compartment, regardless of the orientation of the shock absorber. In addition, because the gas is at a pressure in excess of atmospheric pressure, the shock absorber functions as a gas spring and provides the benefits associated with a pressurized shock absorber. The non-restricted expansion of the bottom wall of the bladder permits the bladder to be always in contact with the hydraulic fluid. Hence, the bladder acts as diaphragm and pressure in the bladder (diaphragm) will be directly transmitted to the hydraulic fluid. Even as the main chamber of the shock absorber is replenished with fluid from the reservoir chamber, the gap in the reservoir chamber is taken up by the ever-expanding bladder (diaphragm), and no cavitation will occur.

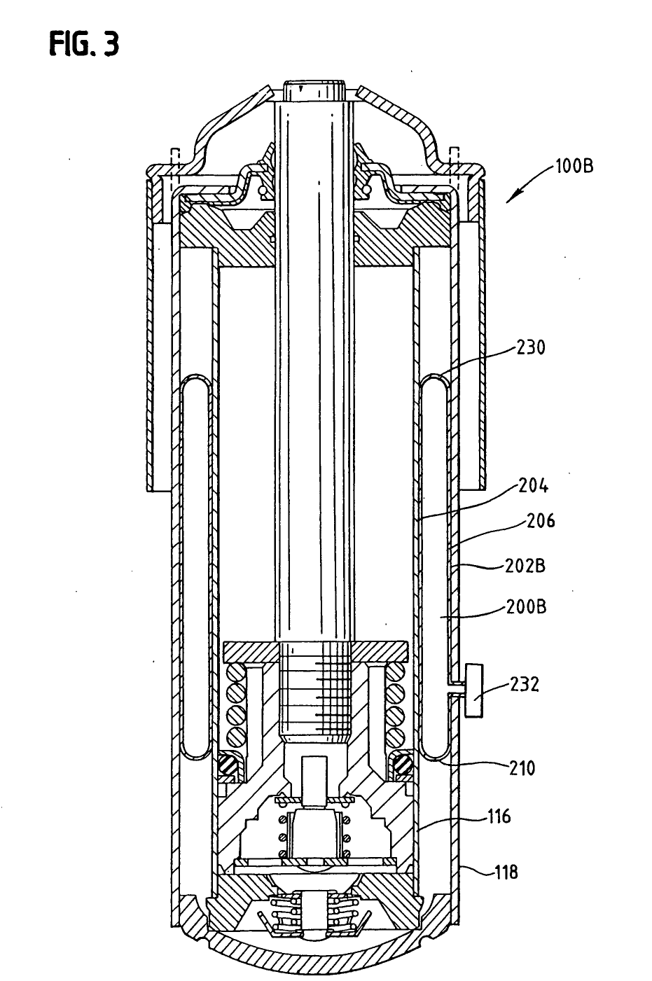

FIG. 3 illustrates a second embodiment of a shock absorber 100B according to certain aspects of the present invention. The shock absorber 100B includes a gas compartment 200B defined by a bladder 202B that is closed on the upper end by a generally U-shaped wall 230. Gas is introduced into the bladder 202B through a means, such as a valve 232, which extends through the outer cylinder 118. As a result, the flow passages 216 are not required in this embodiment, but they may be included as a matter of manufacturing convenience. The exact pressure of the gas within the bladder 202B will depend on the specific application. As with the first embodiment, the pressure will be in the range of 150 psi to 250 psi in a typical application.

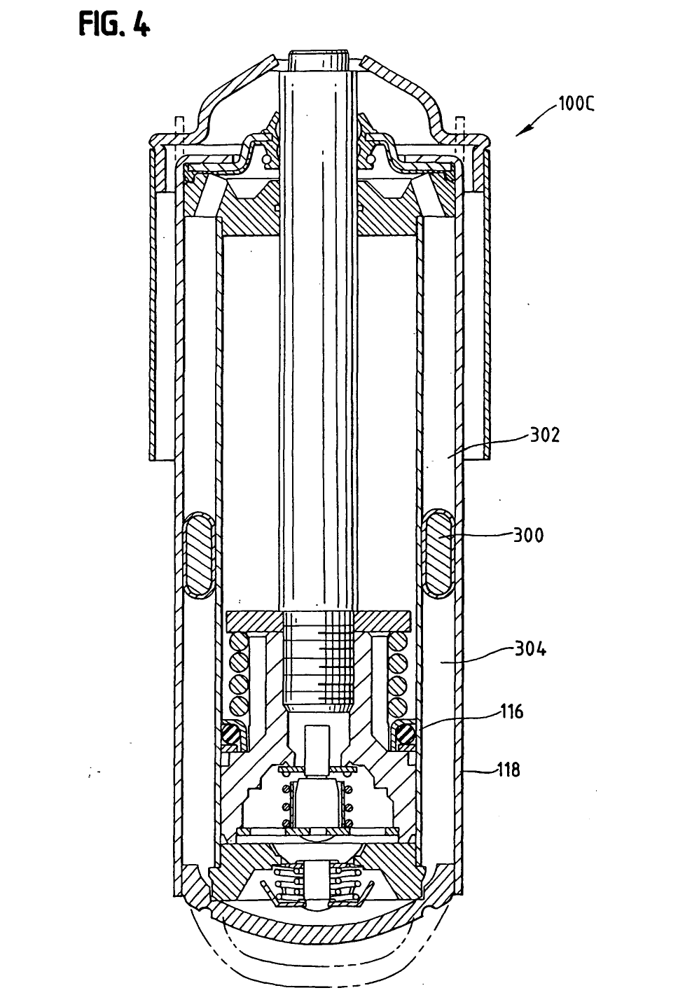

FIG. 4 illustrates a third embodiment of a shock absorber 100C according to certain aspects of the present invention. In this embodiment, the gas bladder is replaced by a member 300 that physically divides the reservoir 122 into a gas compartment 302 (above the member 300 in FIG. 4) and a fluid compartment 304 (below the member 300 in FIG. 4). In the illustrated embodiment, the member 300 is generally ring-shaped. The member 300 can be constructed from an elastomeric material having generally the same properties as the material used to form the bladders 202, 202B in the first and second embodiments. In this respect, the material should be impermeable to oil and gas, be oil resistant, remain resilient through the expected operating temperatures, and have a permanent set of base material less than 5%. Alternatively, the member 300 can, for example, be formed from metal and include appropriate inner and outer seals, which can for example be in the form of elastomeric O-rings. In the illustrated embodiment, the member 300 is solid. It could, alternatively, be hollow in which case it would preferably be filled, e.g., with gas or fluid. The member 300 is sized for reciprocal movement within the reservoir 122, e.g., in response to fluid flow into and out of the fluid compartment 304, while still isolating the pressurized gas from the hydraulic fluid. In this respect, the O.D. of the member 300 forms an interference fit with the I.D. of the outer cylinder 118, whereas the I.D. of the member 300 forms an interference fit with the O.D. of the inner cylinder 116. Pressurized gas is directed into the gas compartment 302, e.g., during assembly, in the manner described above in connection with FIG. 1 to charge the gas compartment to a pressure in excess of atmospheric pressure.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A hydraulic shock absorber comprising, a cylinder structure and a piston structure relatively reciprocating for displacement of hydraulic fluid against flow resistance and including a reservoir structure in flow communication with said cylinder structure receiving fluid so displaced, a deformable gas compartment positioned in the reservoir structure, the gas containing a controlled volume of gas at a pressure in excess of atmospheric pressure, the cylinder structure and the reservoir structure containing a hydraulic fluid filling all portions thereof except for the gas compartment, the gas compartment including an elastomeric member which physically separates the gas in the gas compartment from the hydraulic fluid, the elastomeric member being impermeable to hydraulic fluid flow into the gas compartment and impermeable to gas flow out of the gas compartment.

2. A hydraulic shock absorber as set forth in claim 1, wherein the gas pressure in the gas compartment is on the order of 75 psi or greater.

3. A hydraulic shock absorber as set forth in claim 2, wherein the gas pressure in the gas compartment is in the range of 75 psi to 250 psi.

4. A hydraulic shock absorber as set forth in claim 1, further comprising means for directing pressurized gas into said gas compartment.

5. A hydraulic shock absorber as set forth in claim 4, wherein the means comprises a valve.

6. A hydraulic shock absorber as set forth in claim 1, wherein the elastomeric member comprises a wall.

7. A hydraulic shock absorber as set forth in claim 6, wherein the reservoir structure comprises from an inner cylinder and an outer cylinder, and wherein the wall has an inner section that is generally constrained by the inner cylinder, an outer section that is generally constrained by the outer cylinder and a generally U-shaped section interconnecting the inner and outer sections, the U-shaped section being unconstrained so that it can expand and contract as fluid flows into and out of the reservoir structure.

8. A hydraulic shock absorber as set forth in claim 1, wherein the elastomeric member comprises a ring shaped member mounted for reciprocal sealing movement within the reservoir structure.

9. A hydraulic shock absorber set forth in claim 8, wherein the reservoir compartment is defined by inner and outer cylinders, and wherein the elastomeric member has in inner diameter that forms an interference fit with an outer diameter of the inner cylinder and an outer diameter forming an interference fit with an inner diameter of the outer cylinder.

10. A shock absorber comprising:
an inner cylinder defining an internal chamber that has a rod end and a closed end;
a piston assembly is slidably mounted for reciprocal movement within the internal chamber in a compression stroke direction and in a rebound stroke direction and that defines a rebound compartment adjacent the rod end of the inner cylinder and a compression compartment adjacent the closed end of the inner cylinder, with the volumes of the rebound and compression compartments varying in accordance with the position of the piston assembly in the internal chamber, with the rebound and compression compartments being adapted to be filled with fluid;
a piston rod that is connected to the piston assembly and that extends from the rod end of the internal chamber;
a closure assembly that closes the rod end of the internal chamber and that slidably and sealingly engages about the piston rod;
an outer cylinder defining a reservoir compartment that is in fluid communication with the internal chamber;
a gas compartment positioned in the reservoir compartment, the gas compartment containing a gas at a pressure in excess of atmospheric pressure;
hydraulic fluid filing all of portions of the internal chamber and the reservoir except for the gas compartment;
the gas compartment including a wall formed from an elastomeric material, the wall physically separating the gas in the gas compartment from the hydraulic fluid.

11. The shock absorber of claim 10, wherein the wall has an inner section that is generally constrained by the inner cylinder, an outer section that is generally constrained by the outer cylinder and a generally U-shaped section interconnecting the inner and outer sections, the U-shaped section being unconstrained so that it can expand and contract as fluid flows into and out of the reservoir.

12. A shock absorber as set forth in claim 10, further comprising means for directing pressurized gas into said gas compartment.

13. A shock absorber as set forth in claim 12, wherein the means comprises a valve.

14. A shock absorber as set forth in claim 12, wherein the means comprises a portion of the closure assembly which is displaceable to allow pressurized gas to flow into the gas compartment.

15. A shock absorber as set forth in claim 10, wherein the wall further comprises a generally U-shaped upper wall.

16. A shock absorber as set forth in claim 10, wherein the wall comprises a ring shaped elastomeric member, the ring shaped elastomeric member having an inner diameter that forms an interference fit with an outer diameter of the inner cylinder and an outer diameter having an interference fit with an inner diameter of the outer cylinder, the elastomeric member being reciprocally movable within the reservoir compartment in response to fluid flow into and out of the reservoir compartment.

17. A shock absorber comprising:
an inner cylinder defining an internal chamber that has a rod end and a closed end;
a piston assembly is slidably mounted for reciprocal movement within the internal chamber in a compression stroke direction and in a rebound stroke direction and that defines a rebound compartment adjacent the rod end of the inner cylinder and a compression compartment adjacent the closed end of the inner cylinder, with the volumes of the rebound and compression compartments varying in accordance with the position of the piston assembly in the internal chamber, with the rebound and compression compartments being adapted to be filled with fluid;
a piston rod that is connected to the piston assembly and that extends from the rod end of the internal chamber;
a closure assembly that closes the rod end of the internal chamber and that slidably and sealingly engages about the piston rod;
an outer cylinder defining a fluid reservoir compartment that is in fluid communication with the internal chamber;
a member mounted for reciprocal sealing movement within the reservoir compartment, the member dividing the reservoir compartment into a gas compartment and fluid compartment, the relative sizes of which vary in accordance with the position of the member within the reservoir compartment;
a gas in excess of atmospheric pressure filling the gas compartment; and
hydraulic fluid filing all of portions of the internal chamber and the reservoir except for the gas compartment.

18. A shock absorber as set forth in claim 17, wherein the member is generally ring shaped.

19. A shock absorber as set forth in claim 18, wherein the member has an inner diameter forming an interference fit with an outer diameter of the inner cylinder and an outer diameter forming an interference fit with an inner diameter of the outer cylinder.

20. A shock absorber as set forth in claim 17, wherein the member is formed from an elastomeric material.

21. A hydraulic shock absorber comprising;
a cylinder structure;
a reservoir compartment in flow communication with said cylinder structure;
a gas compartment positioned in the reservoir, the gas compartment containing a gas at a pressure in excess of atmospheric pressure;
the cylinder structure and the reservoir structure containing a hydraulic fluid filling substantially all portions thereof except for the gas compartment; and
a piston structure mounted for reciprocal movement within the cylinder structure.

22. A hydraulic shock absorber as set forth in claim 21, wherein the gas compartment is defined at least in part by an elastomeric member which physically separates the gas in the gas compartment from the hydraulic fluid.

23. A hydraulic shock absorber as set forth in claim 22, wherein the elastomeric member comprises a wall.

24. A hydraulic shock absorber as set forth in claim 23, wherein the reservoir compartment comprises an inner cylinder and an outer cylinder, and wherein the wall has an inner section that is generally constrained by the inner cylinder, an outer section that is generally constrained by the outer cylinder and a generally U-shaped section interconnecting the inner and outer sections, the U-shaped section being unconstrained so that it can expand and contract as fluid flows into and out of the reservoir compartment.

25. A hydraulic shock absorber as set forth in claim 1, further comprising a member mounted for reciprocal sealing movement within the reservoir compartment, the member dividing the reservoir compartment into said gas compartment and a fluid compartment, the relative sizes of which vary in accordance with the position of the member within the reservoir compartment.

26. A hydraulic shock absorber as set forth in claim 1, wherein the member comprises a ring shaped member mounted for reciprocal sealing movement within the reservoir compartment.

27. A hydraulic shock absorber as set forth in claim 1, wherein the member is formed of an elastomeric material.

28. A hydraulic shock absorber set forth in claim 9, wherein the reservoir compartment is defined by inner and outer cylinders, and wherein the member has in inner diameter forming an interference fit with an outer diameter of the inner cylinder and an outer diameter forming an interference fit with an inner diameter of the outer cylinder.

29. A hydraulic shock absorber as set forth in claim 1, wherein the gas compartment is defined by an inflatable bladder.
